(19) United States
(12) Patent Application Publication
(10) Pub. No.: US 2016/0162215 A1
(43) Pub. Date: Jun. 9, 2016

(54) META PLANE OPERATIONS FOR A STORAGE DEVICE

(71) Applicant: SANDISK TECHNOLOGIES INC., Plano, TX (US)

(72) Inventors: MURALITHARAN JAYARAMAN, BANGALORE (IN); RAMPRAVEEN SOMASUNDARAM, BANGALORE (IN); NARENDHIRAN CHINNAANANGUR RAVIMOHAN, BANGALORE (IN)

(73) Assignee: SANDISK TECHNOLOGIES INC.

(21) Appl. No.: 14/603,071

(22) Filed: Jan. 22, 2015

(30) Foreign Application Priority Data
Dec. 8, 2014 (IN) 6181/CHE/2014

(51) Int. Cl. G06F 3/06

(52) U.S. Cl. CPC G06F 3/0625; G06F 3/0653; G06F 3/0659; G06F 3/0679

(57) ABSTRACT

A method of operating a data storage device having a memory includes scheduling a first operation to be performed at one or more memory dies of a first meta plane of a plurality of meta planes of the memory. The first operation is to be performed during a particular time period. The method also includes determining that performance of the first operation consumes less than a threshold amount of power. The method further includes scheduling a second operation to be performed at one or more memory dies of a second meta plane of the plurality of meta planes, or at one of the dies in the same meta plane, during the particular time period and performing the first operation concurrently with the second operation. A peak amount of power corresponding to concurrent execution of the first operation and the second operation is less than the threshold amount of power.

### CROSS-REFERENCE TO RELATED APPLICATIONS

The present application claims priority from Indian Application No. 6181/CHE/2014, filed Dec. 8, 2014, the contents of which are incorporated by reference herein in their entirety.

### FIELD OF THE DISCLOSURE

The present disclosure is generally related to meta plane operations for a storage device.

### BACKGROUND

Non-volatile data storage devices, such as embedded memory devices (e.g., embedded MultiMedia Card (eMMC) devices) and removable memory devices (e.g., removable universal serial bus (USB) flash memory devices and other removable storage cards), have allowed for increased portability of data and software applications. Users of non-volatile data storage devices increasingly rely on the devices to store and provide rapid access to a large amount of data.

Data storage devices can store single-level cell (SLC) data as well as (MLC) data. SLC data and MLC data may be written directly to a memory (e.g., flash memory) of the data storage device. SLC data that has been written to the memory can also be “folded” into MLC data. The memory of a data storage device can be divided into different physical and logical components. For example, the memory can include multiple memory dies, and different groups of memory dies can be divided into different logical “meta planes.” Depending on how fast data is being received from a host device and what types of operations are being performed at the memory, different memory dies may have “idle” time periods and “busy” time periods.

### SUMMARY

The present disclosure presents embodiments in which “idle” time periods that will occur at memory dies of meta planes are identified. Operations, such as maintenance or error-checking operations are scheduled to be performed during the idle time periods. By performing such operations during idle time periods, an overall data rate of the memory may be increased. Different types of operations at a memory may consume different amounts of power, and the memory may have a peak power constraint that should not (or cannot) be exceeded. As an illustrative, non-limiting example, for a memory including 8 memory dies divided into 2 meta planes of 4 memory dies each, the peak power requirement may correspond to write operations concurrently being performed at 5 memory dies. The techniques of the present disclosure may schedule operations to be performed during idle time at different memory dies while maintaining compliance with the peak power constraint.

### BRIEF DESCRIPTION OF THE DRAWINGS

FIG. 1 is a block diagram of a particular illustrative embodiment of a system configured to schedule operations to be performed at a memory of the data storage device;

FIG. 2 is a first timing diagram that illustrates operations performed at the system of FIG. 1;

FIG. 3 is a second timing diagram that illustrates operations performed at the system of FIG. 1;

FIG. 4 is a third timing diagram that illustrates operations performed at the system of FIG. 1;

FIG. 5 is a flow diagram that illustrates a particular example of a method of operation of the data storage device of FIG. 1; and

FIG. 6 is a flow diagram that illustrates another particular example of a method of operation of the data storage device of FIG. 1.

### DETAILED DESCRIPTION

Particular implementations are described with reference to the drawings. In the description, common features are designated by common reference numbers throughout the drawings.

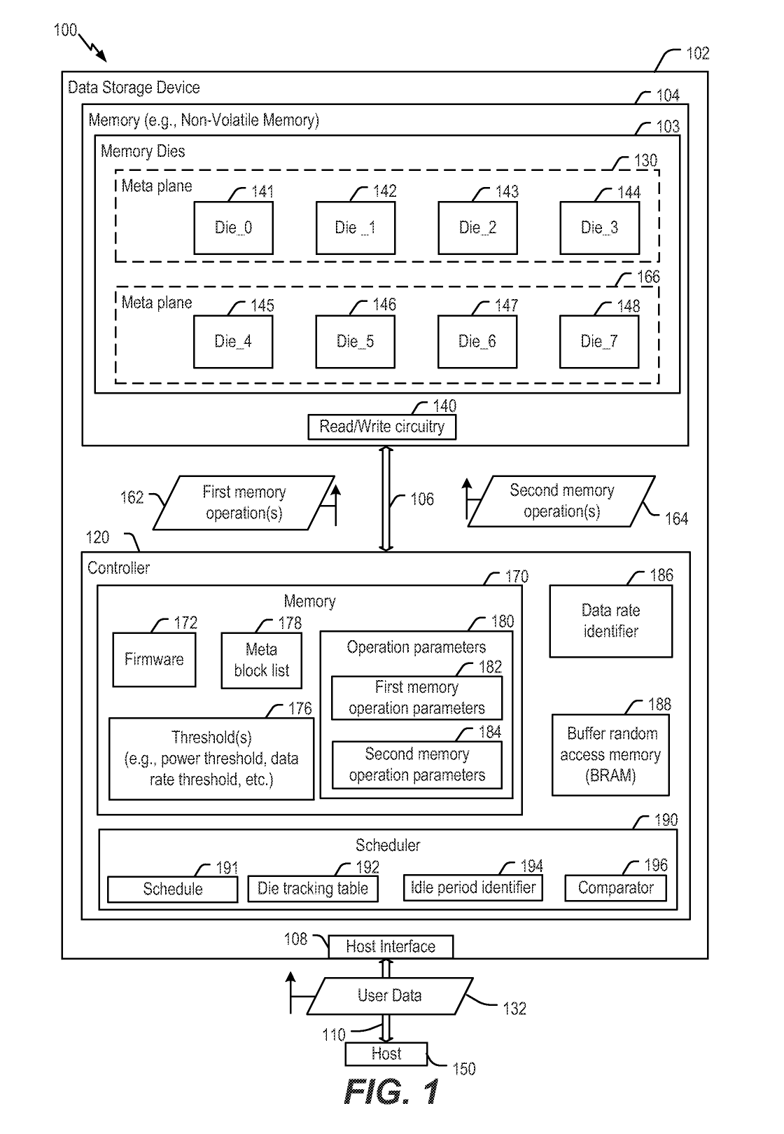

Referring to FIG. 1, a particular illustrative embodiment of a system is depicted and generally designated 100. The system 100 includes a data storage device 102 and a host device 150. The data storage device 102 includes a controller 120 and a memory 104, such as a non-volatile memory, that is coupled to the controller 120. The controller 120 may be configured to identify “idle” time periods that will occur at memory dies of a meta plane of the memory 104 and to schedule operations to be executed at the memory 104 during the idle time periods. For example, the controller 120 may determine that a particular die of the memory 104 is to be idle during execution of a set of operations at a first meta plane of the memory 104. To illustrate, the controller 120 may identify a first idle period of a die included in the first meta plane and/or the controller 120 may identify a second idle period of a second die included in a second meta plane of the memory 104.

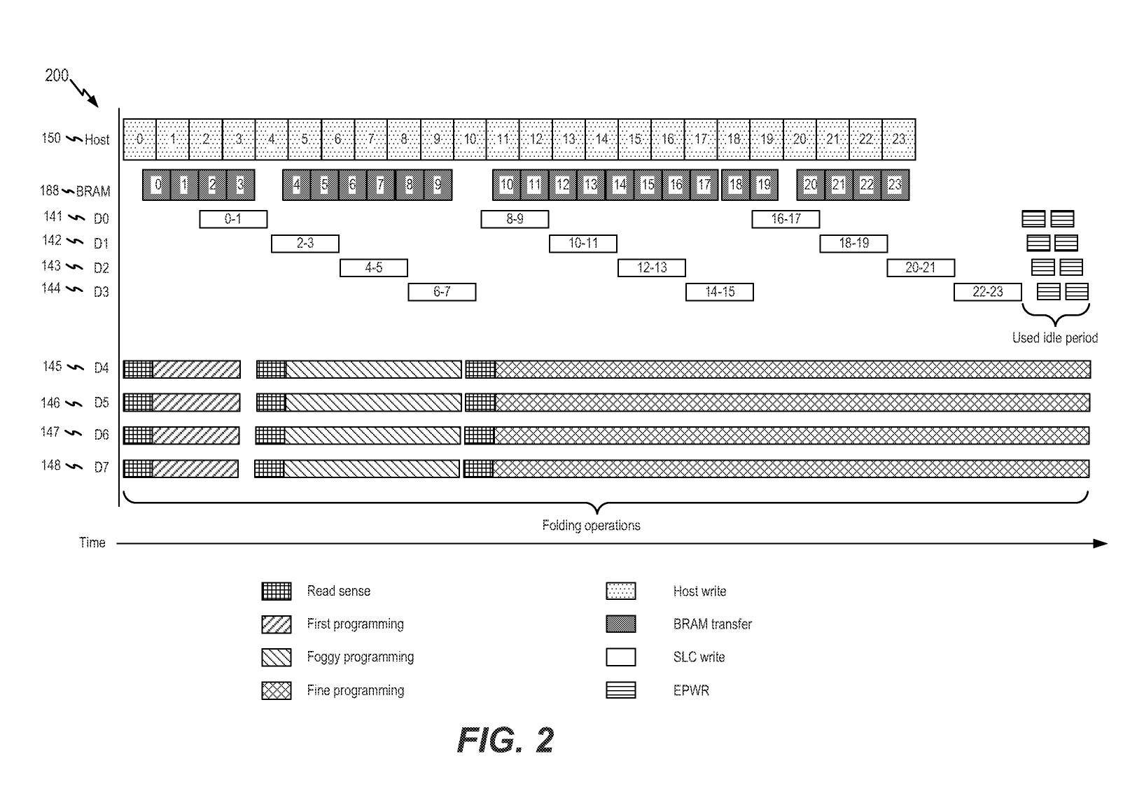

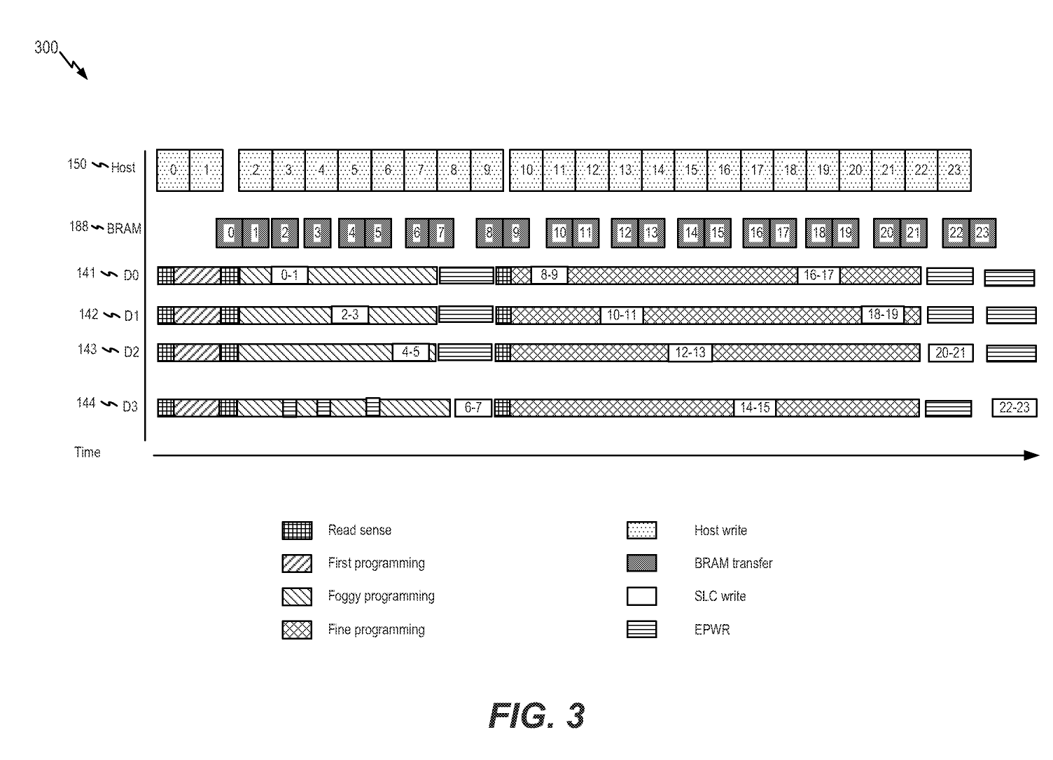

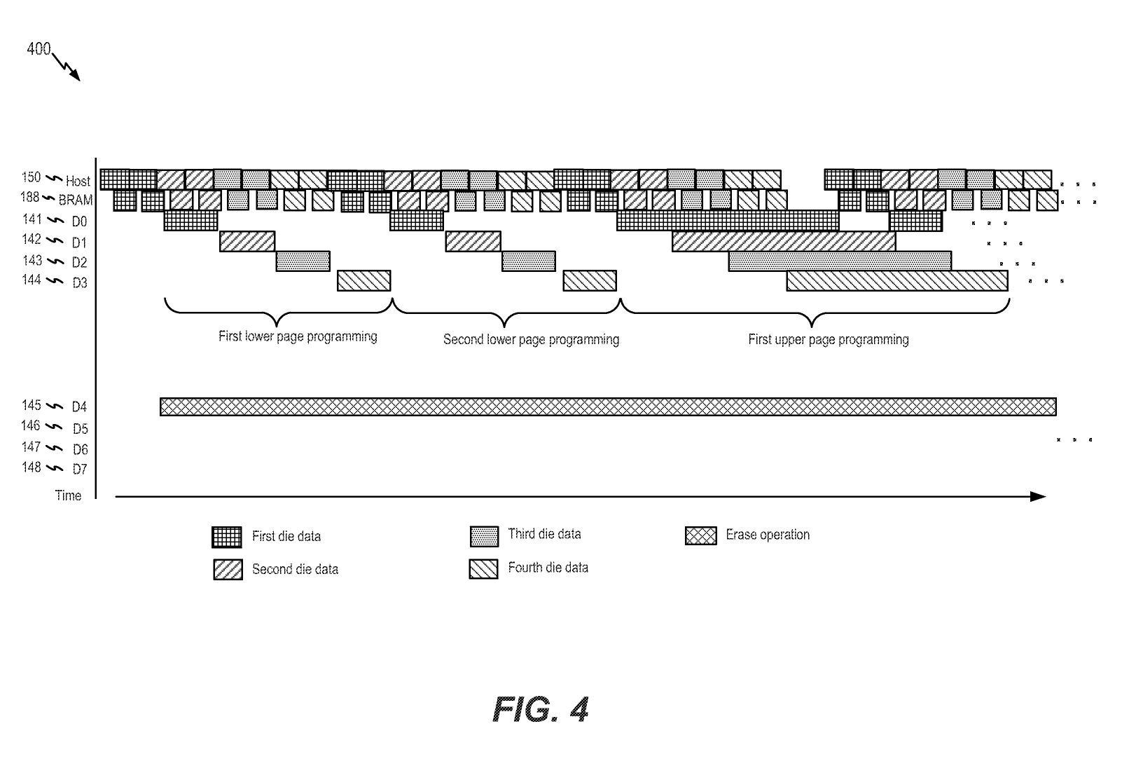

The controller 120 may schedule operations to be performed during the idle time periods, such as a write operation, a maintenance operation, an error-checking operation, or a combination thereof, as illustrative, non-limiting examples. For example, the controller 120 may schedule compaction operations (also known as garbage collection operations) or enhanced post-write read (EPWR) error-checking operations to be performed during idle time periods (associated with a first meta plane) that are identified to occur during erase operations performed at a second meta plane, as described further herein. As another example, the controller 120 may schedule single-level cell (SLC) writing operations and or EPWR error-checking operations to be performed during idle time periods (associated with a first meta plane) that are identified to occur during performance, at a second meta plane, of multi-level cell (MLC) folding operations, as described with reference to FIG. 2. In some implementations, the controller 120 may schedule EPWR error-checking operations to be performed during idle time periods (associated with a meta plane) that are identified to occur during performance, at the meta plane, of SLC writes and MLC folding, as described with reference to FIG. 3. Alternatively, or in addition, the controller 120 may schedule erase operations to be performed during idle time periods (associated with a first meta plane) that are identified to occur during write operations (e.g., MLC writes) performed at a second meta plane, as described with reference to FIG. 4.

By performing such operations during idle time periods, an overall data rate of the memory 104 may be increased. For example, a sequential performance (associated with cycling write operations among multiple meta planes) of the memory 104 may be improved. Additionally, one or more operations may be scheduled to be performed during idle time periods at different memory dies of the memory 104 while maintaining compliance with a peak power constraint that should not (or cannot) be exceeded.

The data storage device 102 and the host device 150 may be operationally coupled via a connection (e.g., a communication path 110), such as a bus or a wireless connection. The data storage device 102 may be embedded within the host device 150, such as in accordance with a Joint Electron Devices Engineering Council (JEDEC) Solid State Technology Association Universal Flash Storage (UFS) configuration. Alternatively, the data storage device 102 may be removable from the host device 150 (i.e., “removably” coupled to the host device 150). As an example, the data storage device 102 may be removably coupled to the host device 150 in accordance with a removable universal serial bus (USB) configuration.

In some implementations, the data storage device 102 may include or correspond to a solid state drive (SSD), which may be used as an embedded storage drive (e.g., a mobile embedded storage drive), an enterprise storage drive (ESD), a client storage device, or a cloud storage drive, as illustrative, non-limiting examples. In some implementations, the data storage device 102 may be coupled to the host device 150 indirectly, e.g., via a network. For example, the data storage device 102 may be a network-attached storage (NAS) device or a component (e.g. a solid-state drive (SSD) device) of a data center storage system, an enterprise storage system, or a storage area network.

The data storage device 102 may be configured to be coupled to the host device 150 via a communication path 110, such as a wired communication path and/or a wireless communication path. For example, the data storage device 102 may include an interface 108 (e.g., a host interface) that enables communication via the communication path 110 between the data storage device 102 and the host device 150, such as when the interface 108 is communicatively coupled to the host device 150.

For example, the data storage device 102 may be configured to be coupled to the host device 150 as embedded memory, such as eMMC® (trademark of JEDEC Solid State Technology Association, Arlington, Va.) and eSD, as illustrative examples. To illustrate, the data storage device 102 may correspond to an eMMC (embedded MultiMedia Card) device. As another example, the data storage device 102 may correspond to a memory card, such as a Secure Digital (SD®) card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). The data storage device 102 may operate in compliance with a JEDEC industry specification. For example, the data storage device 102 may operate in compliance with a JEDEC eMMC specification, a JEDEC Universal Flash Storage (UFS) specification, one or more other specifications, or a combination thereof.

The host device 150 may include a processor and a memory. The memory may be configured to store data and/or instructions that may be executable by the processor. The memory may be a single memory or may include multiple memories, such as one or more non-volatile memories, one or more volatile memories, or a combination thereof. The host device 150 may issue one or more commands to the data storage device 102, such as one or more requests to erase data from, read data from, or write data to the memory 104 of the data storage device 102. For example, the host device 150 may be configured to provide data, such as user data 132, to be stored at the memory 104 or to request data to be read from the memory 104. The host device 150 may include a mobile telephone, a music player, a video player, a gaming console, an electronic book reader, a personal digital assistant (PDA), a computer, such as a laptop computer or notebook computer, any other electronic device, or any combination thereof, as illustrative, non-limiting examples.

The host device 150 communicates via a memory interface that enables reading data from the memory 104 and writing data to the memory 104. For example, the host device 150 may operate in compliance with a Joint Electron Devices Engineering Council (JEDEC) industry specification, such as a Universal Flash Storage (UFS) Host Controller Interface specification. As other examples, the host device 150 may operate in compliance with one or more other specifications, such as a Secure Digital (SD) Host Controller specification, as an illustrative, non-limiting example. The host device 150 may communicate with the memory 104 in accordance with any other suitable communication protocol.

The memory 104 of the data storage device 102 may include a non-volatile memory. The memory 104 may have a two-dimensional (2D) memory configuration. Alternatively, the memory 104 may have another configuration, such as a three-dimensional (3D) memory configuration. For example, the memory 104 may include a three-dimensional (3D) memory configuration that is monolithically formed in one or more physical levels of arrays of memory cells having an active area disposed above a silicon substrate. In some implementations, the memory 104 may include circuitry associated with operation of the memory cells (e.g., storage elements).

The memory 104 may include multiple memory dies 103. For example, the multiple memory dies 103 may include a die_0 141, a die_1 142, a die_2 143, a die_3 144, a die_4 145, a die_5 146, a die_6 147, and a die_7 148. Although the multiple memory dies 103 are depicted as including eight memory dies, in other implementations the multiple memory dies 103 may include more than or fewer than eight memory dies. Each of the multiple memory dies 103 may include one or more blocks (e.g., one or more erase blocks), and each of the blocks may include one or more groups of storage elements. Each group of storage elements may include multiple storage elements (e.g., memory cells) and may be configured as a page or a word line.

A first set of dies of the multiple memory dies 103 may be logically grouped as a first meta plane 130 and a second set of dies of the multiple memory dies 103 may be logically grouped as a second meta plane 166. For example, the first set of dies may include dies 141-144 and the second set of dies may include dies 145-148. Although each of the meta planes 130, 166 are illustrated as having four dies, in other implementations a meta plane may include more than four dies or fewer than four dies. A meta block may include a group of multiple blocks that are located in memory dies of the same meta plane that are processed together as if they were a single large block.

The memory 104 may include support circuitry, such as read/write circuitry 140, to support operation of the multiple memory dies 103. Although depicted as a single component, the read/write circuitry 140 may be divided into separate components of the memory 104, such as read circuitry and write circuitry. The read/write circuitry 140 may be external to the multiple memory dies 103 of the memory 104. Alternatively, one or more individual memory dies may include corresponding read/write circuitry that is operable to read data from and/or write data to storage elements within the individual memory die independent of any other read and/or write operations at any of the other memory dies.

The data storage device 102 includes the controller 120 coupled to the memory 104 (e.g., the multiple memory dies 103) via a bus 106, an interface (e.g., interface circuitry), another structure, or a combination thereof. For example, the bus 106 may include multiple distinct channels to enable the controller 120 to communicate with each of the multiple memory dies 103 in parallel with, and independently of, communication with the other memory dies 103. In some implementations, the memory 104 may be a flash memory.

The controller 120 is configured to receive data and instructions from the host device 150 and to send data to the host device 150. For example, the controller 120 may send data to the host device 150 via the interface 108, and the controller 120 may receive data from the host device 150 via the interface 108. The controller 120 is configured to send data and commands to the memory 104 and to receive data from the memory 104. For example, the controller 120 is configured to send data and a write command to cause the memory 104 to store data to a specified address of the memory 104. The write command may specify a physical address of a portion of the memory 104 (e.g., a physical address of a word line of the memory 104) that is to store the data. The controller 120 may also be configured to send data and commands to the memory 104 associated with background scanning operations, garbage collection operations, and/or wear leveling operations, etc., as illustrative, non-limiting examples. The controller 120 is configured to send a read command to the memory 104 to access data from a specified address of the memory 104. The read command may specify the physical address of a portion of the memory 104 (e.g., a physical address of a word line of the memory 104).

The controller 120 may include a memory 170, a data rate identifier 186, a buffer random-access memory (BRAM) 188, and a scheduler 190. The memory 170 may include firmware 172, a threshold 176, a meta block list 178, and operation parameters 180. The firmware 172 may include or correspond to executable instructions that may be executed by the controller 120, such as a processor included in the controller 120. Responsive to the data storage device 102 being powered up, the firmware 172 may be accessed at the memory 170 and/or stored in the memory 170 (e.g., received from another memory, such as the memory 104, and stored in the memory 170). For example, the firmware 172 may be stored in the other memory (e.g., the memory 104, a read-only memory (ROM) of the controller 120, a memory of the host device 150, or another memory) and may be loaded into the memory 170 in response to a power-up of the data storage device 102.

The threshold 176 may include one or more thresholds used by the scheduler 190, as described further herein. For example, the one or more thresholds may include a power threshold (e.g., a peak power constraint), a data rate threshold, another threshold, or a combination thereof, as illustrative, non-limiting examples. The power threshold may include or correspond to an amount of power that should not (or cannot) be exceeded during execution of one or more operations at the memory 104. The data rate threshold may include or correspond to a data rate of data received from the host device 150 and/or a data rate of data written to the memory 104.

The meta block list 178 may include a list of meta blocks that may be used to store data. The meta block list 178 may indicate a status (e.g., erased or not erased) for each of the meta blocks included in the meta block list 178. For example, the meta block list 178 may be generated and/or maintained by the controller 120 based on one or more instructions included in the firmware 172. The meta block list 178 may be an ordered list that indicates a sequence in which meta blocks of the memory 104 are to be erased (and used to store data). For example, the meta block list 178 may be structured such that an order of meta blocks to be erased alternates (back and forth) between a meta block of the first meta plane 130 and a meta block of the second meta plane 166. Prior to a write operation being issued to a particular meta block, the controller 120 may check the meta block list 178 to determine whether the particular meta block has an erased status or a not erased status. Additionally or alternatively, in response to detection of a meta block failure (e.g., a write failure, a read failure, an erase failure, etc.), the failed meta block may be removed from the meta block list 178 and a new meta block, such as a reserve meta block, may be added to the meta block list 178. The new meta block may be added to the meta block list 178 in the same position (of the meta block list 178) previously occupied by the failed meta block, or the meta block list 178 may be re-ordered responsive to the addition of the new meta block.

The operation parameters 180 may include parameters associated with different memory operations. For example, the operation parameters 180 may include first memory operation parameters 182 associated with a first memory operation, such as a first memory operation 162, and second memory operation parameters 184 associated with a second memory operation, such as a second memory operation 164. One or more parameters for a particular memory operation may include a time period (e.g., an amount of time) to execute the particular memory operation, an amount of power to execute the particular memory operation (e.g., a peak power during execution of the particular memory operation), or a combination thereof, as illustrative, non-limiting examples. The memory operations may include an erase operation, a compaction operation (e.g., a garbage collection operation), an EPWR error-checking operation, a single-level cell (SLC) write operation, a multi-level cell (MLC) write operation (configured to write 2 bits per cell (BPC), 3 BPC, or more than 3 BPC), a folding operation, a SLC read operation, a MLC read operation, a background operation, a wear-leveling operation, a scrubbing operation, a refresh operation, or another operation, as illustrative, non-limiting examples.

During a write operation, data may be written to the memory 104. During a read operation, data may be read from the memory 104. During a folding operation, an internal transfer may occur at the memory 104 where data stored at SLC pages is read and stored at one or more MLC pages. During a wear-leveling operation and/or a garbage collection operation, data may be transferred within the memory 104 for purposes of equalizing wear of different regions of the memory 104 and/or for gathering defragmented data into one or more consolidated regions of the memory 104. During an erase operation, data may be erased from the memory 104. During an EPWR error-checking operation, data written to the memory 104 as MLC data may be verified for accuracy. Background operations may include or correspond to data scrambling, column replacement, handling write aborts and/or program failures, bad block and/or spare block management, error detection code (EDC) functionality, status functionality, encryption functionality, error recovery, and/or address mapping (e.g., mapping of logical to physical blocks), as illustrative, non-limiting examples. During a scrubbing operation, data may be read from the memory 104 and a corrective action may be performed to compensate for disturbs of storage levels, such as program disturbs, read disturbs, and/or erase disturbs. During a refresh operation, data storage levels at a portion of the memory may be maintained to compensate for voltage shifts and to correct incorrect data values.

The data rate identifier 186 may be configured to measure (e.g., detect) a data rate of data received from the host device 150 and/or a data rate of data written to the memory 104. Although the data rate identifier 186 is depicted as being included in the controller 120, in other implementations the data rate identifier 186 may be included in the interface 108, the memory 104, or the host device 150, as illustrative, non-limiting examples.

The buffer random-access memory (BRAM) 188 may be configured to buffer data passed between the host device 150 and the memory 104. For example, data received from the host device 150 may be stored at the BRAM 188 prior to being written to the memory 104. In some implementations, the data received from the host device 150 may be encoded prior to being stored at the BRAM 188. For example, the data may be encoded by an error correction code (ECC) engine (not shown). As another example, data read from the memory 104 may be stored at the BRAM 188 prior to being provided to the host device 150. In some implementations, the data read from the memory 104 may be decoded prior to being stored at the BRAM 188. For example, the data may be decoded by the ECC engine.

The scheduler 190 may be configured to identify idle time periods associated with one or more of the multiple memory dies 103 and to schedule one or more memory operations during the idle time periods, as described herein. The scheduler 190 may include a schedule 191, a die tracking table 192, an idle period identifier 194, and a comparator 196. The scheduler 190 may be configured to use the schedule 191 to schedule (and/or track) one or more operations to be executed at the multiple memory dies 103. The scheduler 190 may be configured to use the die tracking table 192 to monitor (e.g., track) operations performed at each die of the multiple memory dies 103. For example, for each die of the multiple memory dies 103, the die tracking table 192 may include a corresponding entry that indicates whether the die is idle or an operation is being performed at the die, an operation type (e.g., an operation type identifier) that is being performed at the die, an operation start time of an operation being performed by the die, or a combination thereof, as illustrative, non-limiting examples. In some implementations, the die tracking table 192 may maintain a bit map where each bit of the bit map corresponds to a different die of the multiple memory dies 103. A value of a particular bit may indicate a state of a corresponding die. For example, a logical zero value may indicate that the corresponding die is idle and a logical one value may indicate that a memory operation is being performed at the corresponding die.

The idle period identifier 194 may be configured to identify one or more idle time periods associated with the multiple memory dies 103. To illustrate, the scheduler 190 may detect a first memory operation that is initiated to be performed at the memory 104 (e.g., at the die_4 145). The scheduler 190 may determine a time period to complete execution of the first memory operation. For example, the scheduler 190 may determine the time period based on the operation parameters 180, based on a data rate measured by the data rate identifier 186, or a combination thereof, as illustrative, non-limiting examples. Additionally or alternatively, the scheduler 190 may determine states of one or more memory dies of the multiple memory dies 103 throughout the time period. For example, the scheduler 190 may determine the states of the one or more memory dies based on the die tracking table 192, the operation parameters 180, or a combination thereof, as illustrative, non-limiting examples. To illustrate, in response to the first memory operation initiated at the die_4 145, the scheduler 190 (e.g., the idle period identifier 194) may access the die tracking table 192 to determine a state of the die_0 141 and a state of the die_5 146.

Based on the die tracking table 192, the idle period identifier 194 may determine that the die_0 141 is in an idle state and that the die_5 146 is in an active state associated with execution of a second memory operation at the die_5 146. The idle period identifier 194 may calculate an end time of the second memory operation and/or identify an idle time period of the die_5 146 during execution of the first memory operation (e.g., during the time period). In some implementations, the idle period identifier 194 may determine one or more idle time periods each time an operation is initiated to be performed at the memory 104.

The comparator 196 may be configured to perform one or more comparisons. For example, the comparator 196 may compare a data rate measured by the data rate identifier 186 to a threshold data rate of the one or more thresholds 176. To illustrate, the comparator 196 may determine whether the measured data rate is greater than or equal to the threshold data rate. As another example, the comparator 196 may determine a peak power of one or more memory operations concurrently being executed, one or more memory operations that may be scheduled to be concurrently executed, or one or more memory operations scheduled to be concurrently executed at the multiple memory dies 103, as illustrative, non-limiting examples. The comparator 196 may compare the peak power to a peak power threshold (e.g., a peak power constraint) of the one or more thresholds 176. If the peak power is greater than or equal to the peak power threshold, an overload condition may be present in the data storage device 102 which may damage one or more components and/or circuits of the data storage device 120. The comparator 196 may provide an indication (e.g., a flag) responsive to a determination that a combined peak power associated with one or more memory operations is greater than or equal to the peak power threshold. In some implementations, the peak power threshold may be greater than a peak amount of power used during write operations that are concurrently performed at each memory die of a single meta plane. For example, if a single meta plane includes 4 memory dies, the peak power threshold may be greater than a peak amount of power used during write operations that are concurrently performed at the four memory dies. To illustrate, the peak power threshold may be greater than or equal to a peak amount of power used during write operations that are concurrently performed at five memory dies.

During operation, the data storage device 102 may be powered on (e.g., a power-up event may be initiated). Responsive to the power-up event, the firmware 172 may be loaded into and/or access from the memory 170. As part of the power-up event or following completion of the power-up event, the controller 120 may be configured to initiate a set of erase operations to erase a set of blocks of the first set of dies. For example, immediately following completion of the power-up event, the controller 120 may identify a meta block to be erased based on the meta block list 178 and may initiate one or more erase operations to erase the meta block. Erasing the meta block may prepare the data storage device 102 to write data at the memory 104, such as incoming data that may be received from the host device 150.

After the meta block is erased, the controller 120 may determine (e.g., identify) a first memory operation 162 to be performed at the first set of dies (associated with the first meta plane 130). In some implementations, the first memory operation 162 may include a first set of one or more memory operations to be executed at the first meta plane 130, such as a set of write operations to write data to the erased meta block. The controller 120 (e.g., the scheduler 190) may determine a particular time period (e.g., an execution time period) to complete execution of the first memory operation 162. The controller may generate the schedule 191 to include the first memory operation 162.

The controller 120 may determine one or more idle time periods associated with the second set of dies (associated with the second meta plane 166) during the particular time period. A power consumption during each of the one or more idle time periods may be less than a threshold amount of power. The controller 120 may identify a candidate operation (e.g., a second memory operation 164) to be performed during at least one idle time period of the one or more idle time periods. The second memory operation 164 may be an SLC write operation, an MLC write operation, a folding operation, a wear-leveling operation, a scrubbing operation, a refresh operation, a garbage collection operation (e.g., a compaction operation), an erase operation, an enhanced post-write read (EPWR) error-checking operation, or a combination thereof, as illustrative, non-limiting examples. In some implementations, the second memory operation 164 may include a set of one or more memory operations to be executed at the second set of dies (associated with the second meta plane 166).

The controller 120 may access the second memory operation parameters 184 to determine a peak power of the second memory operation 164 and may predict whether concurrent execution of the second memory operation 164 and the first memory operation 162 during the at least one idle time period would result in a peak power of the memory 104 to exceed a peak power threshold. If execution of the second memory operation 164 and the first memory operations 164 is determined to be less than or equal to the peak power threshold, the controller 120 may schedule the second memory operation 164 to begin at a second die of the second set of dies during the at least one idle time period (e.g., during the execution time period of the first memory operation 162). For example, the controller 120 may update the schedule to include the second memory operation 164. Accordingly, the controller 120 may be configured to determine one or more idle time periods associated with execution of the first memory operation 162 and to identify and schedule the second memory operation 164 to be performed during execution of the first memory operation 162.

In some implementations, the first memory operation 162 (e.g., a first set of operations) may include a set of erase operations and the second memory operation 164 may include one or more compaction operations (e.g., garbage collection operations) and/or one or more EPWR error-checking operations. When the second memory operation 164 includes the one or more compaction operations, the controller 120 may be configured to access the operation parameter 180 (e.g. stored parameter data) to identify a first duration of the set of erase operations and to identify a second duration of compaction of a page of the memory 104 during a compaction operation. The controller 120 may determine a number of pages of the memory 104 (e.g., of the second meta plane 166) on which to perform the one or more compaction operations based on the first duration divided by the second duration. When the second memory operation 164 includes the EPWR error-checking operations, the controller 120 may be configured to access the operation parameter 180 (e.g. stored parameter data) to identify a first duration of the set of erase operations and to identify a third duration of verification of a page of the memory 104 during an EPWR error-checking operation. The controller 120 may determine a number of pages of the memory 104 (e.g., of the second meta plane 166) on which to perform the one or more EPWR error-checking operations based on the first duration divided by the third duration.

In other implementations, the first memory operation 162 (e.g., a first set of operations) may include a set of SLC write operations and the second memory operation 164 may include a MLC write operation, such as a folding operation. Alternatively, the first memory operation 162 (e.g., a first set of operations) may include a set of MLC write operations, such as a set of folding operation, and the second memory operation 164 may include one or more SLC write operations, as described with reference to FIG. 2. In other implementations, the first memory operation 162 (e.g., a first set of operations) may include a set of MLC write operations and the second memory operation 164 may include an EPWR error-checking operation. The set of MLC write operations may include direct write operations to write data, such as incoming data received from the host device 150, to the first set of dies (associated with the first meta plane 130). In other implementations, the first memory operation 162 (e.g., a first set of operations) may include a set of MLC write operations (e.g., MLC direct write operations) and the second memory operation 164 may include an erase operation, as described with reference to FIG. 4.

Although the controller 120 has been described as identifying one or more idle time periods of the second set of dies that may occur during execution of the first memory operation 162 at the first set of dies, additionally or alternatively, the controller 120 may identify one or more idle time periods of the first set of dies that may occur during execution of the first memory operations 162 at the first set of dies. To illustrate, the controller 120 may be configured to identify an incoming data rate of data received from a host device 150, and the controller 120 may be configured to initiate a first set of operations at the first set of dies, such as a first set of operations to write the data to the first set of dies. The controller 120 may compare the incoming data rate to a threshold rate (e.g., a threshold rate selected from the one or more thresholds 176). In response to a determination that the incoming data rate is greater than the threshold rate, the controller 120 may determine an execution time period (e.g., a time duration) of the first set of operations based on the operation parameters 180. In response to a determination that the incoming data rate is less than or equal to the threshold rate, the controller 120 may calculate a duration of the execution time period (of the first set of operations) based on the incoming data rate, a first amount of time to transfer data from a buffer random-access memory (BRAM) 188 to the memory 104, a second amount of time to write the data into the memory 104, or a combination thereof.

After the execution time period of the first set of operations is determined, the controller 120 may determine (e.g., identify) one or more idle time periods associated with the first set of dies (associated with the first meta plane 130) during the execution time period of the first set of operations. The controller 120 may select and schedule a particular memory operation (or set of memory operations) to be performed at one or more dies of the first set of dies during the one or more idle time periods. For example, when the first set of operations includes performing SLC write operations at the first set of dies (associated with the first meta plane 130), the particular memory operation may include a folding operation, as described with reference to FIG. 3.

In some implementations, the firmware 172, the meta block list 178, the one or more thresholds 176, the operation parameters 180, the schedule 191, the die tracking table 192, or a combination thereof, may be stored at the memory 104. In other implementations, the controller 120 may include or may be coupled to a particular memory (e.g., the memory 170), such as a random access memory (RAM), that is configured to store the firmware 172, the meta block list 178, the one or more thresholds 176, the operation parameters 180, the schedule 191, the die tracking table 192, or a combination thereof. Alternatively, or in addition, the controller 120 may include or may be coupled to another memory (not shown), such as a non-volatile memory, a RAM, or a read only memory (ROM). The other memory may be a single memory component, multiple distinct memory components, and/or may indicate multiple different types (e.g., volatile memory and/or non-volatile) of memory components. In some embodiments, the other memory may be included in the host device 150.

In some implementations, the data storage device 102 may include an error correction code (ECC) engine. The ECC engine may be configured to receive data, such as the user data 132, and to generate one or more error correction code (ECC) codewords (e.g., including a data portion and a parity portion) based on the data. For example, the ECC engine may receive the user data 132 and may generate a codeword. To illustrate, the ECC engine may include an encoder configured to encode the data using an ECC encoding technique. The ECC engine may include a Reed-Solomon encoder, a Bose-Chaudhuri-Hocquenghem (BCH) encoder, a low-density parity check (LDPC) encoder, a turbo encoder, an encoder configured to encode the data according to one or more other ECC techniques, or a combination thereof, as illustrative, non-limiting examples.

The ECC engine may include a decoder configured to decode data read from the memory 104 to detect and correct bit errors that may be present in the data. For example, the ECC engine may correct a number of bit errors up to an error correction capability of an ECC technique used by the ECC engine. A number of errors identified by the ECC engine may be tracked by the controller 120, such as by the ECC engine. For example, based on the number of errors, the ECC engine may determine a bit error rate (BER) associated with the memory 104.

Although one or more components of the data storage device 102 have been described with respect to the controller 120, in other implementations certain components may be included in the memory 104. For example, one or more of the memory 170, the data rate identifier 186, the BRAM 188, the scheduler 190, the idle period identifier 194, and/or the comparator 196 may be included in the memory 104. Alternatively, or in addition, one or more functions as described above with reference to the controller 120 may be performed at or by the memory 104. For example, one or more functions of the memory 170, the data rate identifier 186, the BRAM 188, the scheduler 190, the idle period identifier 194, and/or the comparator 196 may be performed by components and/or circuitry included in the memory 104. Alternatively, or in addition, one or more components of the data storage device 102 may be included in the host device 150. For example, one or more of the memory 170, the data rate identifier 186, the BRAM 188, the scheduler 190, the idle period identifier 194, and/or the comparator 196 may be included in the host device 150. Alternatively, or in addition, one or more functions as described above with reference to the controller 120 may be performed at or by the host device 150.

By identifying idle time periods and scheduling one or more operations during the idle time periods, the data storage device 102 may increase an overall data rate of the memory 104. For example, the data storage device 102 may schedule operations to be concurrently performed on multiple meta planes. As another example, when an incoming data rate associated with a set of write operations performed at a particular meta plane is slow (e.g., less than a threshold rate), the data storage device may schedule additional operations to be performed at the particular meta plane during execution of the set of write operations. Additionally, the operations scheduled by the data storage device 102 may be executed in compliance with a peak power constraint so that damage to the memory 104 resulting from an overload condition may be avoided.

Referring to FIG. 2, a particular illustrative embodiment of a first timing diagram of operations performed at the system 100 is depicted and generally designated 200. For example, the first timing diagram 200 illustrates host data 0-23 transferred from the host device 150 to the data storage device 102 (e.g., to the BRAM 188), BRAM data 0-23 transferred from the BRAM 188 to the memory 104 (e.g., to one or more of the memory dies 141-148), and operations performed at the memory dies 141-148 (D0-D7).

Prior to receiving the host data 0-23 from the host device 150, the data storage device 102 may receive an indication that the host device 150 is going to send the host data 0-23 to be written to the memory 104 (e.g., written to the memory dies 141-144 (D0-D3) associated with the first meta plane 130). The data storage device 102 may schedule the host data 0-23 to be written to the memory dies 141-144 (D0-D3) as a set of SLC write operations.

In response to the set of SLC write operations being scheduled, the data storage device 102 may update the die tracking table 192 to indicate that the memory dies 141-144 are to perform the set of SLC write operations. After scheduling the SLC write operations, the data storage device 102 may identify one or more idle time periods associated with the multiple memory dies 103. For example, the data storage device 102 may determine that the memory dies 145-148 (associated with the second meta plane 166) are idle (e.g., not active) throughout a duration of the execution of the SLC write operations. The data storage device 102 may schedule another set of operations, such as a set of folding operations, to be performed at the memory dies 145-148 (D4-D7) (associated with the second meta plane 166) during the execution of the set of SLC write operations. The set of folding operations may be configured to consolidate SLC data into MLC data associated with storing 3 bits per cell (BPC). The set of folding operations may include read sense operations (e.g., to read data from SLC portions of the memory 104) and multi-stage programming operations, which may be referred to as first-foggy-fine programming operations.

In some implementations, the data storage device 102 may determine whether a peak power constraint is satisfied prior to scheduling another set of operations (e.g., the set of folding operations). As an illustrative, non-limiting example, the peak power constraint may be equal to a peak amount of power consumed by five memory dies that are each concurrently executing a write operation. If the peak power constrained is exceeded, an overload condition may occur at the data storage device 120 that may damage one or more components and/or circuits of the data storage device 120. To illustrate, the data storage device 102 may schedule the set of folding operations after a determination that the peak power constraint is not to be exceeded by concurrently performing the set of SLC write operations and the set of folding operations. For example, if the peak power constraint is greater than or equal to peak power consumed by 5 dies that concurrently perform write operations and since the duration of folding one word line of data may be 12 times longer than a duration of an SLC write operation, the data storage device 102 can decide to perform SLC writes one die at a time (at a first meta plane) and to concurrently perform the folding at four other dies (of a second meta plane). This way, the same amount of data that is folded from SLC to MLC (at the dies of the second meta plane) is accepted from the host as SLC data in the other meta plane (e.g., the first meta plane).

After scheduling the set of folding operations, the data storage device 102 may update the die tracking table 192 to reflect the scheduled set of folding operations and may identify one or more idle time periods that may occur during execution of the set of folding operations. For example, the data storage device 102 may identify one or more idle time periods associated with the first meta plane 130 (e.g., the dies 141-144) that occur after the set of SLC write operations is completed. The data storage device 102 may schedule an additional set of operations, such as a set of EPWR error-checking operations, to be performed at the memory dies 141-144 (D0-D3) during the identified idle time periods. A peak power of concurrently executing the four EPWR error-checking operations may be less than or equal to a peak amount of power to perform a write operation, such as a SLC write operation, at a single memory die. After scheduling the set of EPWR error-checking operations, the data storage device 102 may update the die tracking table 192 to reflect the scheduled set of EPWR error-checking operations

Referring to the timing diagram 200, operations performed by each of the host device 150, the controller 120, and the memory dies 141-148 (D0-D7) during a particular time period are depicted. For example, operations performed by the host device 150 may include host device 150 to BRAM 188 transfers and operations performed by the controller 120 may include BRAM 188 to memory die 141-148 (D0-D7) transfers. The set of folding operations may be performed at the memory dies 145-148 (D5-D8). In parallel with performing the set of folding operations, the host device 150 may transfer the host data 0-23 to the BRAM 188. The host data 0-23 may be received at the data storage device 102 and stored in the BRAM 188. The controller 120 may transfer the BRAM data 0-23 (e.g., the received host data 0-23) from the BRAM 188 to the memory 104 that includes the memory dies 141-148 (D0-D7). In some implementations, each group of the host data 0-23 and each group of the BRAM data 0-23 may include 16 kilobytes of data. The memory 104 may receive the BRAM data 0-23 and perform SLC write operations at each of the memory dies 141-144 (D0-D3). Accordingly, the host data 0-23 may be received from the host device 150 and stored at the memory dies 141-144 (D0-D3).

After the set of SLC write operations are completed, the set of EPWR error-checking operations may be performed at the memory dies 141-144 (D0-D3). The EPWR error-checking operations may check an accuracy of data (e.g., MLC data) stored at the memory dies 141-144 (D0-D3) prior to execution of the set of SLC operations. The set of EPWR error checking operations may be performed concurrently with the set of folding operations.

Referring to FIG. 3, a particular illustrative embodiment of a second timing diagram of operations performed at the system 100 is depicted and generally designated 300. For example, the first timing diagram 300 illustrates host data 0-23 transferred from the host device 150 to the data storage device 102 (e.g., to the BRAM 188), BRAM data 0-23 transferred from the BRAM 188 to the memory 104 (e.g., to one or more of the memory dies 141-148), and operations performed at the memory dies 141-144 (D0-D3).

Prior to receiving the host data 0-23 from the host device 150, the data storage device 102 may receive an indication that the host device 150 is going to send the host data 0-23 to be written to the memory dies 141-144 (D0-D3). The data storage device 102 may schedule the host data 0-23 to be written to the memory dies 141-144 (D0-D3) (associated with the first meta plane 130) as a set of SLC write operations.

The data storage device 102 may determine an incoming data rate associated with data received from the host device 150 and may compare the incoming data rate to a threshold data rate. For example, the incoming data rate may be determined based on data received from the host device prior to receiving the host data 0-23. If the incoming data rate is greater than or equal to the threshold data rate, the data storage device 102 may use one of the stored operation parameters 180 that indicates an execution time period to perform the set of SLC write operations. If the incoming data rate is less than the threshold data rate, the data storage device 102 may calculate an execution time period to complete the SLC write operations based on the incoming data rate. The timing diagraph 300 depicts host data 0-23 transferred from the host device 150 to the BRAM 188 after a determination that the incoming data rate is less than the threshold data rate.

The data storage device 102 may identify one or more idle time periods (associated with the memory dies 141-144 (D0-D3)) to occur during the execution time period. The data storage device 102 may schedule another set of operations, such as a set of folding operations, to be performed at the memory dies 141-144 (D0-D3) during the execution of the set of SLC write operations. The set of folding operations may include read sense operations (e.g., to read data from SLC portions of the memory 104), first programming operations, foggy programming operations, and fine programming operations. After scheduling the set of folding operations, the data storage device 102 may identify one or more idle time periods that may occur during execution of the set of folding operations and/or during the execution time period of the set of SLC write operations. For example, the data storage device 102 may identify one or more idle time periods associated with the dies 141-144 (D0-D3) and may schedule an additional set of operations, such as set of EPWR error-checking operations, to be performed.

Referring to the timing diagram 300, operations performed by each of the host device 150, the BRAM 188, and the memory dies 141-144 (D0-D3) during a particular time period are depicted. For example, the set of folding operations may be performed at the memory dies 141-144 (D0-D3). In parallel with performing the set of folding operations, the host device 150 may transfer the host data 0-23 to the data storage device 102. The host data 0-23 may be received at the data storage device 102 and stored in the BRAM 188. The controller 120 may transfer the BRAM data 0-23 (e.g., the received host data 0-23) from the BRAM 188 to the memory 104 that includes the memory dies 141-148 (D0-D7). The memory 104 may receive the BRAM data 0-23 and perform SLC write operations at each of the memory dies 141-144 (D0-D3). During execution of the set of SLC write operations and the set of folding operations, the set of EPWR error-checking operations may be executed as scheduled. The EPWR error-checking operations may check an accuracy of data (e.g., MLC data) that was stored at the memory dies 141-144 (D0-D3) prior to execution of the set of folding operations.

Although the timing diagrams 200, 300 have been described as scheduling the set of SLC write operations prior to scheduling the set of folding operations, in other implementations, the set of folding operations may be scheduled prior to the set of SLC write operations. Additionally, although the set of folding operations has been described as being selected to be performed with reference to the timing diagrams 200, 300, in other implementations another set of operations may be selected to be performed, such as a set of erase operations, a set of EPWR operations, a set of compaction operations, another set of operations, or a combination thereof, as illustrative, non-limiting examples. Additionally, the data storage device 102 may schedule one or more EPWR error-checking operations rather than scheduling one or more erase operations or one or more compaction operations. For example, scheduling EPWR error-checking operations may have a higher priority than scheduling the erase operations and/or the compaction operations. If there are no EPWR error-checking operations to be performed, the data storage device 102 may schedule one or more erase operations rather than scheduling one or more compaction operations (e.g., the erase operations may have a higher priority than the compaction operations).

Referring to FIG. 4, a particular illustrative embodiment of a third timing diagram of operations performed at the system 100 is depicted and generally designated 400. For example, the first timing diagram 400 illustrates host data transferred from the host device 150 to the data storage device 102 (e.g., to the BRAM 188), BRAM data transferred from the BRAM 188 to the memory 104 (e.g., to one or more of the memory dies 141-148), and operations performed at one or more of the memory dies 141-148 (D0-D8).

Prior to receiving the host data from the host device 150, the data storage device 102 may receive an indication that the host device 150 is going to send the host data to the data storage device 102 to be written to the memory dies 141-144 (D0-D3). The data storage device 102 may schedule the host data 0-23 to be written to the memory dies 141-144 (D0-D3) as a set of MLC direct write operations (that store 2 BPC).

In response to the set of MLC direct write operations being scheduled, the data storage device 102 may update the die tracking table 192. After scheduling the MLC write operations, the data storage device 102 may identify one or more idle time periods of the memory dies 145-148 (D4-D7) (associated with the second meta plane 166) that may occur during execution of the MLC direct write operations. The data storage device 102 may schedule another set of operations, such as a set of erase operations, to be performed at the memory dies 145-148 (D4-D7) during the execution of the set of MLC direct write operations. In some implementations, the data storage device 102 may schedule a set of operations other than the set of erase operations. The set of erase operations may be scheduled to erase a meta block of the second meta plane 166 (associated with the memory dies 145-148 (D4-D7)). The set of erase operations may be scheduled to be performed one die at a time so that a peak power threshold is not exceeded during concurrent execution of the set of MLC direct operations and the set of erase operations. After scheduling the set of erase operations, the data storage device 102 may update the die tracking table 192 to indicate that the memory dies 145-148 (D4-D7) are scheduled to perform the set of erase operations.

Referring to the timing diagram 400, operations performed by each of the host device 150, the controller 120, and the memory dies 141-148 (D0-D7) during a particular time period are depicted. For example, the host device 150 may transfer the host data 0-23 that is received at the data storage device 102 and stored in the BRAM 188. The controller 120 may transfer the BRAM data (e.g., the received host data) from the BRAM 188 to the memory 104 that includes the memory dies 141-148 (D0-D3). The memory 104 may receive the BRAM data and may perform MLC direct write operations at each of the memory dies 141-144 (D0-D3). Performing the MLC direct write operations may include performing interleaved lower page programming across the memory dies of the first meta plane and performing interleaved upper page programming across the memory dies of the first meta plane, as described herein. To illustrate, the memory dies 141-144 (D0-D3) may program a lower page of a first wordline of a block of each of the memory dies 141-144 (D0-D3), and the memory dies 141-144 (D0-D3) may program a lower page of a second wordline of the same block of each of the memory dies 141-144 (D0-D3). After programming the lower pages, an upper page of the first wordline and an upper page of the second wordline may be programmed After programming the lower page and the upper page of the first wordline and the second wordline of the block, additional wordlines of the block may be programmed (in sets of two wordlines) until an entirety of the block is programmed. Accordingly, the timing diagram 400 depicts a portion, and not an entirety, of the MLC direct write operations being executed. Although the timing diagram 400 depicts the MLC direct write operations programming a lower page and an upper page (e.g., 2 bits per cell (BPC)), in other implementations the MLC direct write operations may program more than 2 BPC, such as 3 BPC which includes programming a lower page, a middle page, and an upper page.

In parallel with the MLC direct write operations being performed, the set of erase operations may be performed at the memory dies 145-148 (D4-D8) (e.g., the second meta plane 166). The set of erase operations may be performed so that one erase operation is performed at a time. The timing diagram 400 depicts a first erase operation performed at the memory die 145 (D4). Although not illustrated in the timing diagram 400, after execution of the first erase operation, a second erase operation may be performed on the memory die 146 (D5), followed by a third erase operation performed on the memory die 147 (D6), followed by a fourth erase operation performed on the memory die 148 (D7).

In some implementations, a duration of the set of erase operations may be less than a duration of the set of MLC direct operations. The data storage device 102 may identify one or more idle time periods of the memory dies 145-148 (D4-D7) that occur after completion of the set of erase operations and may schedule another set of one or more operations to be executed at the memory dies 145-148 (D4-D7) during the one or more time periods. For example, the other set of one or more operations may include a set of compaction operations that are scheduled and performed at the memory dies 145-148 (D4-D7) during the one or more time periods.

Thus, the timing diagrams 200, 300, and 400 each illustrate performance of one or more operations during previously identified idle time periods. By performing such operations during idle time periods, an overall data rate of the memory 104 that includes the multiple dies 141-147 (D0-D7) may be increased.

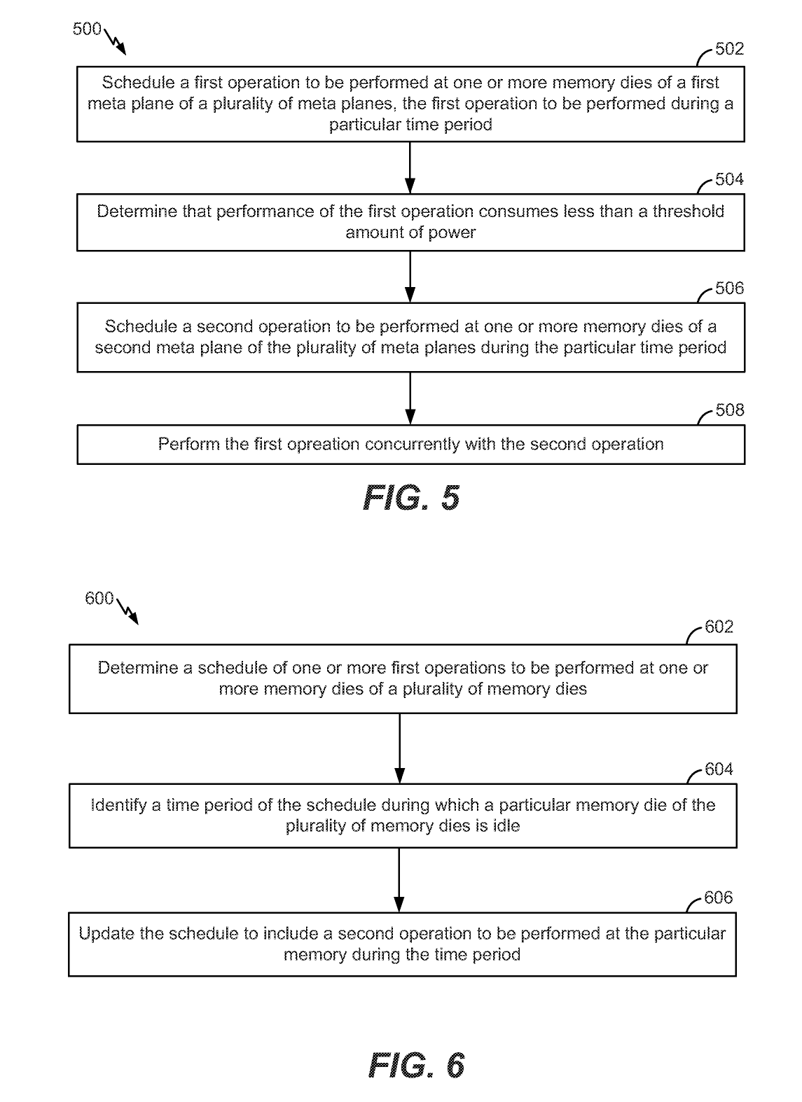

Referring to FIG. 5, a particular illustrative embodiment of a method is depicted and generally designated 500. The method 500 may be performed at the data storage device 102, such as by the scheduler 190, the controller 120, a processor or circuitry configured to execute the firmware 172 of FIG. 1, or a combination thereof, as illustrative, non-limiting examples.

The method 500 includes determining a first operation to perform at one or more memory dies of a first meta plane of a plurality of meta planes, the first operation to be performed during a particular time period, at 502. A peak amount of power corresponding to concurrent execution of the first operation and the second operation may be less than the threshold amount of power. The first operation may include or correspond to the first memory operation 162 of FIG. 1. The plurality of meta planes may be included in a memory of the data storage device, such as the memory 104 of FIG. 1. The plurality of meta planes may include the first meta plane and a second meta plane. For example, the plurality of meta planes may include the meta planes 130, 166 of FIG. 1. Each meta plane of the plurality of meta planes may include a plurality of memory dies. For example, the first meta plane may include a first number of memory dies and the second meta plane may include a second number of memory dies that is the same as or different than the first number of memory dies.

The method 500 also includes determining that performance of the first operation consumes less than a threshold amount of power, at 504. The threshold amount of power may correspond to a peak power constraint associated with the memory. For example, the threshold amount of power may correspond to a particular peak amount of power of multiple operations that are to be concurrently performed at the plurality of meta planes. To illustrate, when each of the first number of memory dies and the second number of memory dies is 4 dies, the peak power constraint may indicate that operations (each using a maximum amount of power per die) may be concurrently performed at 5 memory dies. A comparator, such as the comparator 196 of FIG. 1, may compare the particular peak amount of power of the multiple operations that are to be concurrently performed at the plurality of meta planes to the threshold amount of power (e.g., one of the thresholds 176 of FIG. 1).

The method 500 also includes scheduling a second operation to be performed at one or more memory dies of a second meta plane of the plurality of meta planes during the particular time period, at 506. The second operation may include or correspond to the second memory operation 164 of FIG. 1. The second operation may be performed during one or more idle time periods (corresponding to the second meta plane) that occur during the particular time period.

The method 500 further includes performing the first operation concurrently with the second operation, at 508. For example, the first operations may be performed at the one or more memory dies of the first meta plane, such as the dies 141-144 (D0-D3) of the first meta plane 130 of FIG. 1. The second operations may be performed at the one or more memory dies of the second meta plane, such as the dies 145-148 (D4-D7) of the second meta plane 166 of FIG. 1.

In some implementations, the first operation may include folding single-level cell (SLC) data stored at the first meta plane into multi-level cell (MLC) data. The second operation may include a SLC write operation that is performed at the second meta plane one memory die at a time. The SLC write operation may be based on data received from a host device, such as the host device 150 of FIG. 1, coupled to the data storage device. Additionally or alternatively, the second operation may include an EPWR error-checking operation. The EPWR error-checking operation may be performed to verify accuracy of MLC data stored at the second meta plane, such as MLC data that was written to the second meta plane as part of a folding operation performed prior to the particular time period.

In other implementations, the first operation may include a multi-level cell (MLC) direct write operation and the second operation may include an erase operation. The erase operation may be performed at the second meta plane one memory die at a time. Alternatively, the second operation may include erase operations that are concurrently performed on multiple memory dies of the second meta plane. The MLC write operation may be performed by interleaving lower page programming across the memory dies of the first meta plane and interleaving upper page programming across the memory dies of the first meta plane, as described above with reference to FIG. 4. For example, the MLC write operation may iteratively perform lower page programming, followed by upper page programming, across multiple sets of one or more wordlines of a block of each memory die of the first meta plane.

In other implementations, the first operation may include an erase operation performed at the first meta plane, and the second operation may include a compaction operation and/or an EPWR operation (e.g., an EPWR error-checking operation) performed at the second meta plane. If the second operation includes the compaction operation, a first number of pages on which to perform the compaction operation may be determined. For example, the first number of pages may be determined based on a duration of the erase operation and/or based on an amount of time to complete each EPWR operation, as indicated by operation parameters included in the operation parameters 180 of FIG. 1. If the second operation includes the EPWR operation, a second number of pages on which to perform the EPWR operation may be determined. The first number of pages may be determined based on a duration of the erase operation and/or based on an amount of time to complete each EPWR operation, as indicated by operation parameters included in the operation parameters 180 of FIG. 1.

By determining that the first operation associated with the first meta plane consumes less than the threshold amount of power, the second operation may be selected and scheduled to be performed on the second meta plane. By scheduling and executing the second operation, one or more operations in addition to the first operation may be performed during the time period to execute the first operation. Accordingly, scheduling and executing the second operation may increase an overall data rate of the memory of the data storage device.

Referring to FIG. 6, a particular illustrative embodiment of a method is depicted and generally designated 600. The method 600 may be performed at the data storage device 102, such as by the scheduler 190, the controller 120, a processor or circuitry configured to execute the firmware 172 of FIG. 1, or a combination thereof, as illustrative, non-limiting examples.

The method 600 includes determining a schedule of one or more first operations to be performed at one or more memory dies of a plurality of memory dies, at 602. The schedule may include or correspond to the schedule 191 of FIG. 1. The one or more first operations may include or correspond to the first memory operation 162 of FIG. 1. The plurality of memory dies may be included in a memory of the data storage device, such as the memory 104 of FIG. 1. The plurality of memory dies may include or correspond to the multiple memory dies 103, such as the dies 141-148 of FIG. 1. In some implementations, the plurality of memory dies may be grouped into one or more meta planes, such as the meta planes 130, 166 of FIG. 1.

The method 600 also includes identifying a time period of the schedule during which a particular memory die of the plurality of memory dies is idle, at 604. The time period may include or correspond to one or more idle time periods of the plurality of memory dies. The time period of the schedule may be identified based on one or more operational parameters associated with the one or more first operations. For example, the one or more operational parameters may include or correspond to the operational parameters 180 of FIG. 1.

The method 600 further includes updating the schedule to include a second operation to be performed at the particular memory die during the time period, at 606. The second operation may include or correspond to the second memory operation 164 of FIG. 1. The one or more first operations and the second operation may be executed according to the schedule. For example, after the schedule is updated, the controller may initiate the first operation and the second operation to be executed at the memory.

In some implementations, the one or more first operations may include a folding operation and the second operation may include an EPWR error-checking operation. Additionally or alternatively, the one or more first operations may include a SLC write operation. If the one or more first operations include the folding operation and the SLC write operation, the EPWR operation may be selected for scheduling based on a rate (e.g., a rate is associated with a transfer of data from a host device, such as the host device 150 of FIG. 1, to the data storage device) being less than or equal to a threshold rate.

By scheduling the second operation to be performed during the time period, an overall data rate of the memory of the data storage device may be increased. For example, the second operation may be scheduled during an idle time period of a die of the plurality of dies that would otherwise go unused (e.g., no operation would be performed at the die during the idle time period).

The method 500 of FIG. 5 and/or the method 600 of FIG. 6 may be initiated or controlled by an application-specific integrated circuit (ASIC), a processing unit, such as a central processing unit (CPU), a controller, another hardware device, a firmware device, a field-programmable gate array (FPGA) device, or any combination thereof. As an example, the method 500 of FIG. 5 and/or the method 600 of FIG. 6 can be initiated or controlled by one or more processors, such as one or more processors included in or coupled to a controller or a memory of the data storage device 102 and/or the host device 150 of FIG. 1. A controller configured to perform the method 500 of FIG. 5 and/or the method 600 of FIG. 6 may be able to schedule meta plane operations for a storage device.

In an illustrative example, a processor may be programmed to schedule a first operation to be performed at one or more memory dies of a first meta plane of a plurality of meta planes, the first operation to be performed during a particular time period. For example, the processor may execute instructions to detect the first operation to be performed, to access a schedule data structure, and/or to generate a first entry in the schedule data structure. The processor may further execute instructions to determine that performance of the first operation consumes less than a threshold amount of power. For example, the processor may execute instructions to access a parameter data structure that includes operation parameters, to retrieve a peak power of the first operation from the parameter data structure, to retrieve a value corresponding to the threshold amount of power, and/or to compare at the peak power to the threshold amount of power. The processor may further execute instructions to schedule a second operation to be performed at one or more memory dies of a second meta plane of the plurality of meta planes during the particular time period. For example, the processor may execute instructions to select the second operation, to access a schedule data structure, and/or to generate a second entry in the schedule data structure. The processor may further execute instructions to perform the first operation concurrently with the second operation. For example, the processor may execute instructions to generate a first command corresponding to the first operation, to send the first command to the memory, to generate a second command corresponding to the second operation, and/or to send the second command to the memory.

In another illustrative example, a processor may be programmed to determine a schedule of one or more first operations to be performed at one or more memory dies of a plurality of memory dies. For example, the processor may execute instructions to detect the one or more first operations to be performed, to access a schedule data structure, and/or to generate a first entry in the schedule data structure. The processor may further execute instructions to identify a time period of the schedule during which a particular memory die of the plurality of dies is idle. For example, the processor may execute instructions to access a parameter data structure that includes operation parameters, to retrieve a time period parameter of the first set of operations from the parameter data structure, to access a die tracking table, to identify an entry of the die tracking table having a status of idle during a time period corresponding to the time period parameter. The processor may further execute instructions to update the schedule to include a second operation to be performed at the particular memory dies during the time period. For example, the processor may execute instructions to access the schedule data structure and/or to generate a second entry in the schedule data structure.

Although various components of the data storage device 102 and/or the host device 150 of FIG. 1 are depicted herein as block components and described in general terms, such components may include one or more microprocessors, state machines, or other circuits configured to enable the various components to perform operations described herein. One or more aspects of the various components may be implemented using a microprocessor or microcontroller programmed to perform operations described herein, such as one or more operations of the method 500 of FIG. 5 and/or the method 600 of FIG. 6. In a particular implementation, each of the controller 120, the memory 104, the memory 170, and/or the host 150 of FIG. 1 includes a processor executing instructions that are stored at a memory, such as a non-volatile memory of the data storage device 102 or the host device 150 of FIG. 1. Alternatively or additionally, executable instructions that are executed by the processor may be stored at a separate memory location that is not part of the non-volatile memory, such as at a read-only memory (ROM) of the data storage device 102 or the host device 150 of FIG. 1.

With reference to FIG. 1, the data storage device 102 may be attached to or embedded within one or more host devices, such as within a housing of a host communication device (e.g., the host device 150). For example, the data storage device 102 may be integrated within an apparatus, such as a mobile telephone, a computer (e.g., a laptop, a tablet, or a notebook computer), a music player, a video player, a gaming device or console, an electronic book reader, a personal digital assistant (PDA), a portable navigation device, or other device that uses non-volatile memory. However, in other embodiments, the data storage device 102 may be implemented in a portable device configured to be selectively coupled to one or more external host devices. In still other embodiments, the data storage device 102 may be a component (e.g., a solid-state drive (SSD)) of a network accessible data storage system, such as an enterprise data system, a network-attached storage system, a cloud data storage system, etc.

To further illustrate, the data storage device 102 may be configured to be coupled to the host device 150 as embedded memory, such as in connection with an embedded MultiMedia Card (eMMC®) (trademark of JEDEC Solid State Technology Association, Arlington, Va.) configuration, as an illustrative example. The data storage device 102 may correspond to an eMMC device. As another example, the data storage device 102 may correspond to a memory card, such as a Secure Digital (SD®) card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). The data storage device 102 may operate in compliance with a JEDEC industry specification. For example, the data storage device 102 may operate in compliance with a JEDEC eMMC specification, a JEDEC Universal Flash Storage (UFS) specification, one or more other specifications, or a combination thereof. In yet another particular embodiment, the data storage device 102 is coupled to the accessing device 150 indirectly, e.g., via a network. For example, the data storage device 102 may be a network-attached storage (NAS) device or a component (e.g. a solid-state drive (SSD) device) of a data center storage system, an enterprise storage system, or a storage area network.

The memory 104 and/or the memory 170 of FIG. 1 may include a resistive random access memory (ReRAM), a three-dimensional (3D) memory, a flash memory (e.g., a NAND memory, a NOR memory, a single-level cell (SLC) flash memory, a multi-level cell (MLC) flash memory, a divided bit-line NOR (DINOR) memory, an AND memory, a high capacitive coupling ratio (HiCR) device, an asymmetrical contactless transistor (ACT) device, or another flash memory), an erasable programmable read-only memory (EPROM), an electrically-erasable programmable read-only memory (EEPROM), a read-only memory (ROM), a one-time programmable memory (OTP), or a combination thereof. Alternatively, or in addition, the memory 104 and/or the memory 170 may include another type of memory. The memory 104 and/or the memory 170 of FIG. 1 may include a semiconductor memory device.

Semiconductor memory devices include volatile memory devices, such as dynamic random access memory (“DRAM”) or static random access memory (“SRAM”) devices, non-volatile memory devices, such as magnetoresistive random access memory (“MRAM”), resistive random access memory (“ReRAM”), electrically erasable programmable read only memory (“EEPROM”), flash memory (which can also be considered a subset of EEPROM), ferroelectric random access memory (“FRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure. In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate). As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of a non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor material such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Alternatively, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically used for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this disclosure is not limited to the two dimensional and three dimensional illustrative structures described but cover all relevant memory structures within the scope of the disclosure as described herein and as understood by one of skill in the art. The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Those of skill in the art will recognize that such modifications are within the scope of the present disclosure.

The above-disclosed subject matter is to be considered illustrative, and not restrictive, and the appended claims are intended to cover all such modifications, enhancements, and other embodiments, that fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
at a data storage device including a memory, the memory including a plurality of meta planes, each meta plane including a plurality of memory dies, performing:
scheduling a first operation to be performed at one or more memory dies of a first meta plane of the plurality of meta planes, the first operation to be performed during a particular time period;
determining that performance of the first operation consumes less than a threshold amount of power;
scheduling a second operation to be performed at one or more memory dies of a second meta plane of the plurality of meta planes during the particular time period; and
performing the first operation concurrently with the second operation, wherein a peak amount of power corresponding to concurrent execution of the first operation and the second operation is less than the threshold amount of power.

2. The method of claim 1, wherein the threshold amount of power corresponds to a peak power constraint associated with the memory.

3. The method of claim 1, wherein:
the first meta plane includes a first number of memory dies;
the second meta plane includes a second number of memory dies; and
the threshold amount of power corresponds to a particular peak amount of power of multiple operations that are concurrently performed at the plurality of meta planes.

4. The method of claim 1, wherein the first operation comprises folding single-level cell (SLC) data stored at the first meta plane into multi-level cell (MLC) data.

5. The method of claim 4, wherein the second operation comprises a SLC write operation.

6. The method of claim 5, wherein the SLC write operation is performed at the second meta plane one memory die at a time.

7. The method of claim 5, wherein the SLC write operation is based on data received from a host device coupled to the data storage device.

8. The method of claim 4, wherein the second operation comprises an enhanced post-write read (EPWR) operation.

9. The method of claim 8, further comprising performing, prior to the particular time period, a folding operation to write MLC data at the second meta plane, wherein the EPWR operation is performed to verify accuracy of the MLC data written at the second meta plane.

10. The method of claim 1, wherein the first operation comprises a single-level cell (SLC) write operation, and wherein the second operation comprises an erase operation.

11. The method of claim 10, wherein the erase operation is performed at the second meta plane one memory die at a time.

12. The method of claim 1, wherein the first operation comprises a multi-level cell (MLC) direct write operation.

13. The method of claim 12, wherein performing the MLC direct write operation includes performing interleaved lower page programming across the memory dies of the first meta plane and performing interleaved upper page programming across the memory dies of the first meta plane.

14. The method of claim 1, wherein the first operation comprises an erase operation, and wherein the second operation comprises a compaction operation.

15. The method of claim 14, further comprising:
accessing stored parameter data to identify a first duration of the erase operation and to identify a second duration of compaction of a page of the memory during the compaction operation; and
determining a number of pages on which to perform the compaction operation based on the first duration divided by the second duration.

16. The method of claim 1, wherein the first operation comprises an erase operation, and wherein the second operation comprises an enhanced post-write read (EPWR) operation.

17. The method of claim 16, further comprising:
accessing stored parameter data to identify a first duration of the erase operation and to identify a third duration of verification of a page of the memory during the EPWR operation; and
determining a number of pages on which to perform the EPWR operation based on the first duration divided by the second duration.

18. A data storage device comprising:
a memory including multiple dies, wherein a first set of dies of the multiple dies are grouped as a first meta plane and a second set of dies of the multiple dies are grouped as a second meta plane; and
a controller coupled to the memory, wherein the controller is configured to determine a first set of operations to be performed at the first set of dies during a particular time period and to determine one or more idle time periods associated with the second set of dies during the particular time period, wherein the controller is further configured to schedule a second operation to be performed at a second die of the second set of dies during at least one of the one or more idle time periods, and wherein a peak power consumption corresponding to multiple operations concurrently performed at the multiple memory dies during the particular time period is less than a threshold.

19. The data storage device of claim 18, wherein the memory is configured to store first duration data corresponding to a first amount of time to complete execution of the first set of operations and second duration data corresponding to a first amount of time to complete execution of the second operation, and wherein the controller is configured to track an operation type identifier and an operation start time for each operation performed at each of the multiple dies.

20. The data storage device of claim 18, wherein the second operation is a garbage collection operation, an erase operation, an enhanced post-write read (EPWR) operation, a folding operation, a multi-level cell (MLC) write, a single-level cell (SLC) write operation, or a combination thereof.

21. The data storage device of claim 18, wherein the memory includes firmware, and wherein, responsive to a power-up event, the firmware is loaded from the memory to the controller and the controller is configured to initiate a set of erase operations to erase a set of blocks of the first set of dies, and wherein the first set of operations are configured to write data to the set of blocks.

22. A method comprising:
at a data storage device including a memory, the memory includes a meta plane that includes a plurality of memory dies, performing:
determining a schedule of one or more first operations to be performed at one or more memory dies of the plurality of memory dies;
identifying a time period of the schedule during which a particular memory die of the plurality of memory dies is idle; and
updating the schedule to include a second operation to be performed at the particular memory die during the time period.

23. The method of claim 22 further comprising performing the one or more first operations and the second operation according to the updated schedule, wherein the one or more first operations include a folding operation, and wherein the second operation includes an enhanced post-write read (EPWR) operation.

24. The method of claim 23, wherein the one or more first operations further include a single-level cell (SLC) write operation, and wherein the EPWR operation is selected for scheduling based on a rate being less than or equal to a threshold rate, wherein the rate is associated with a transfer of data from a host device to the data storage device.

25. A data storage device comprising:
a memory including a first set of dies associated with a first meta plane and a second set of dies associated with a second meta plane; and
a controller coupled to the memory, wherein the controller is configured to determine an incoming data rate of data received from a host device and to initiate a first set of operations at the first set of dies, wherein, in response to a determination that the incoming data rate is less than or equal to a threshold rate, the controller is configured to determine an idle time period of a first die of the first set of dies during an execution period of the first set of operations and to initiate a particular operation at the first die during the idle time period.

26. The data storage device of claim 25, further comprising a buffer random-access memory configured to store the data received from the host device, wherein the controller is configured to calculate a duration of the execution period based on the incoming data rate, a first amount of time to transfer the received data from the buffer random-access memory to the memory, a second amount of time to write the data into the memory, or a combination thereof.

27. The data storage device of claim 25, wherein the first set of operations includes a set of single-level cell (SLC) write operations, and wherein the particular operation includes a multi-level cell (MLC) write operation.

28. The data storage device of claim 25, wherein the first set of operations includes a set of multi-level cell (MLC) write operations, and wherein the particular operation includes an enhanced post-write read (EPWR) operation, a garbage collection operation, an erase operation, a folding operation, or other background operation.

29. The data storage device of claim 25, wherein the first set of operations includes a set of multi-level cell (MLC) direct write operations to write the incoming data at the first set of dies.

30. The data storage device of claim 25, wherein the memory includes a three-dimensional (3D) memory configuration that is monolithically formed in one or more physical levels of arrays of memory cells having an active area disposed above a silicon substrate, and wherein the memory includes circuitry associated with operation of the memory cells.
